(19) United States
(12) Patent Application Publication
(10) Pub. No.: US 2014/0297326 A1
(43) Pub. Date: Oct. 2, 2014

(54) ELECTRONIC MEDICAL SYSTEM AND METHOD

(71) Applicant: Kashif A. Firozvi, Potomac, MD (US)

(72) Inventor: Kashif A. Firozvi, Potomac, MD (US)

(21) Appl. No.: 14/222,846

(22) Filed: Mar. 24, 2014

Related U.S. Application Data
(60) Provisional application No. 61/805,509, filed on Mar. 26, 2013.

(51) Int. Cl. G06Q 50/24; G06F 19/00; G06Q 10/10

(52) U.S. Cl. CPC G06Q 50/24; G06Q 10/10; G06F 19/322
USPC 705/3

(57) ABSTRACT

A system and method for providing personalized healthcare information and records specific to healthcare delivery includes obtaining by a processor, (i) a first subscription fee from a patient for a physician to access (a) enhanced communication link for communication between the patient for the physician, and (b) healthcare information and records that are specific to a healthcare delivery of the patient, and (ii) a second subscription fee from the physician for utilizing a service provided by a system, enabling the patient to access a consultation room that provides on-demand peer-to-peer consultations and on-demand communication between the patient and at least one of the physician and an entity, enabling the patient to access an educational facility stored in the database, and generating (i) suggestions comprising health awareness activities for the patient, health reports, and recommended prescriptions based on at least one of the health awareness activities and health reports.

### CROSS-REFERENCE TO RELATED APPLICATION

This application claims the benefit of U.S. Provisional Application No. 61/805,509 filed on Mar. 26, 2013, the complete disclosure of which, in its entirety, is herein incorporated by reference.

### BACKGROUND

1. Technical Field

The embodiments herein generally relate to electronic medical healthcare systems, and more particularly to an electronic medical healthcare system and method for providing personalized healthcare information and records specific to healthcare delivery by enabling access to an enhanced communication link between a patient and a physician.

2. Description of the Related Art

The healthcare system is growing in terms of complexity and level of sophistication in regards to the quality of care being administered to patients. In 2011, national health-related spending was estimated to have reached approximately $2.7 trillion, growing at the same rate of 3.9% observed in 2010 (spending was estimated at $2.3 trillion in 2008—more than triple what was spent in 1990, $714 billion, and eight times what was spent in 1980). 75% of these expenditures are related to the management of chronic diseases such as heart disease, cancer, pulmonary disorders, and diabetes. The process of providing and managing care for these chronic disease populations is complex, expensive, and presents profound challenges in communication and coordination of care between a physician and a patient. Mobile technology will transform the healthcare industry with increased productivity gains saving $305 billion over the next 10 years, according to a new report by the Deloitte Center for Health Solutions. The savings will come from reduced travel time, better logistics, faster decision-making and improved communications, among other improvements. A 2012 Brookings Institution study predicts that remote monitoring technologies will save nearly $200 billion by managing chronic diseases in the U.S. over the next 25 years. Deloitte points out other estimates that suggest remote monitoring can reduce the costs for caring for the elderly in rural areas by allowing seniors to live independently and spend more time at home, while reducing the need for face to-face medical consultations, by 25%.

Cutting healthcare costs is imperative if America is to get a handle on its tremendous debt and out-of-control healthcare spending. With healthcare consuming 18% of U.S. gross domestic product, mobile health technology plays a key element of the healthcare industry's response to the market's quest for value. According to Deloitte, “mHealth technologies are a valuable partner in healthcare's shift towards a delivery model that is patient-centered and value-based. The power and reach of mobile communications offers great versatility and utility to enable provision of high-quality, low-cost health services.” Most of the expenditures are related to the management of chronic diseases such as heart disease, cancer, pulmonary disorders, and diabetes. The process of providing and managing care for these chronic disease populations is complex, expensive, and presents profound challenges in communication and coordination of care between a physician and a patient. Remote monitoring of the patient can reduce the costs for caring for the elderly in rural areas by allowing seniors to live independently and spend more time at home, while reducing the need for face to-face medical consultations.

In a 2012 survey from a health analytics and services firm, Optum Institute noted that consumers are eager to use online healthcare tools, but physician systems are not yet up to par. While 70% of physicians surveyed said they have basic Electronic Medical Record (EMR) capabilities, only 40% of physicians have the capability to engage with patients via an email or provide patients with access to their health records. This poses a major problem because consumers are ready to use technology-enabled features. Three out of four consumers say they are willing to go online to view their medical records, and more than 60% want to communicate with their doctors via email or the Internet.

Recognizing that care coordination is a key component to achieving better care and health for individuals and reducing expenditure growth, The Centers for Medicare Services (CMS) has implemented several new programs to provide payment for such services, including post-discharge transitional care management (TCM) payments. In the 2013 physician fee schedule, CMS created such payments for physicians and certain non-physician practitioners. While CMS states that generally care coordination is a component of an Evaluation and Management (E/M) service, CMS acknowledged that such payments may not be sufficient to support comprehensive management of certain categories of patients, such as those being discharged from institutions to community-based care. Accordingly, CMS has adopted CPT TCM codes 99495 and 99496, with certain modifications, for a single physician who provides care coordination services to a patient within thirty days of the patient's discharge from a hospital, psychiatric hospital, long-term care hospital, skilled nursing facility, or partial hospitalization at a community mental health center to community based care.

The acknowledgement that TCM services are separate and distinct from E/M codes is a step in the right direction for coordinating care for patients. Further, it may be a helpful tool in reducing hospital readmission rates which is a primary focus in CMS's attempt to reduce costs. Accordingly, there remains a need for a system that unites and balances stakeholders' (e.g., patients and their families, physicians, and payors) incentives by providing an array of services through its mobile devices enabling better care coordination, increased patient engagement, and improved satisfaction among its users.

### SUMMARY

In view of the foregoing, an embodiment herein provides a system for providing personalized healthcare information and records specific to a healthcare delivery, the system comprising a processor; a database; a memory storing computer-executable instructions, wherein the processor executes the computer-executable instructions; a subscription fee obtaining module executed by the processor, wherein the subscription fee obtaining module obtains (i) a first subscription fee from a patient for a healthcare provider, wherein the first subscription fee is specific to access (a) a communication link for communication between the patient and the healthcare provider, and (b) healthcare information and records that are specific to a healthcare delivery of the patient, and (ii) a second subscription fee from the healthcare provider for utilizing a service provided by the system; a registration module executed by the processor that registers the patient and the healthcare provider based on the first subscription fee and the second subscription fee; a consultation module executed by the processor that enables the patient to access an electronically configured virtual consultation room that provides on-demand peer-to-peer consultations and on-demand communication between the patient and at least one of the healthcare provider and an entity; and a medical education module executed by the processor that enables the patient to access electronic data of an educational facility stored in the database.

The system may further comprise a health monitoring module executed by the processor, wherein the health monitoring module generates (i) suggestions comprising health awareness activities for the patient, (ii) health reports based on the health awareness activities, and (iii) recommended prescriptions based on at least one of the health awareness activities and the health reports. The system may further comprise a personal health record module executed by the processor, wherein the personal health record module enables (i) the patient an on-demand access to the healthcare provider to retrieve clinical data from a personal health record stored in the database, and (ii) coordination care by linking the patient and the healthcare provider. The system may further comprise a transcription module executed by the processor, wherein the transcription module enables the patient an on-demand access to a remotely accessible transcription service.

The on-demand communication between the patient, the healthcare provider, and the entity may comprise an interactive session comprising any of an audio conference, a video conference, and a short message service (SMS). The audio conference, the video conference, and the SMS may be integrated with any of Personal Health Records (PHR) and Electronic Health Records (EMR) associated with the patient and the healthcare provider. The database may store data associated with the patient, the healthcare provider, and other expert healthcare providers. The entity may comprise any of family members and friends associated with the patient, another healthcare provider, and a payer of healthcare services.

Another embodiment provides a system for providing personalized healthcare information and records specific to a healthcare delivery, the system comprising a processor; a database; a first computer-executable module executed by the processor, wherein the first module obtains (i) a first subscription fee from a patient for a healthcare provider, wherein the first subscription fee is specific to access (a) a communication link for communication between the patient and the healthcare provider, and (b) healthcare information and records that are specific to a healthcare delivery of the patient, and (ii) a second subscription fee from the healthcare provider for utilizing a service provided by the system; a second computer-executable module executed by the processor, wherein the second computer-executable module registers the patient and the healthcare provider based on the first subscription fee and the second subscription fee; a third computer-executable module executed by the processor, wherein the third computer-executable module enables the patient to access an electronic virtual consultation room that provides on-demand peer-to-peer consultations and on-demand communication between the patient and at least one of the healthcare provider and an entity; a fourth computer-executable module executed by the processor, wherein the fourth computer-executable module enables the patient to access electronic data from an educational facility stored in the database; a fifth computer-executable module executed by the processor, wherein the fifth computer-executable module generates (i) suggestions comprising health awareness activities for the patient, (ii) health reports based on the health awareness activities, and (iii) recommended prescriptions based on at least one of the health awareness activities and the health reports; and a sixth computer-executable module executed by the processor, wherein the sixth computer-executable module enables (i) the patient an on-demand communicative access to the healthcare provider to retrieve clinical data from a personal health record stored in the database, and (ii) coordination care by linking the patient and the healthcare provider.

The system may further comprise a seventh computer-executable module executed by the processor, wherein the seventh computer-executable module enables the patient an on-demand communicative access to a remotely located transcription service. The on-demand communication between the patient, the healthcare provider, and the entity may comprise an interactive session comprising any of an audio conference, a video conference, and a short message service (SMS). The system may further comprise a communication device that facilitates access and interaction to the system by any of the patient, the healthcare provider, and an entity. The entity may comprise any of family members and friends associated with the patient, another healthcare provider, and a payer of healthcare services.

Another embodiment provides a method for providing personalized healthcare information and records specific to a healthcare delivery, the method comprising obtaining, by a processor (i) a first subscription fee from a patient for a healthcare provider, wherein the first subscription fee is specific to access (a) a communication link for communication between the patient and the healthcare provider, and (b) healthcare information and records that are specific to a healthcare delivery of the patient, and (ii) a second subscription fee from the healthcare provider for utilizing a service provided by the system; registering, by the processor, the patient and the healthcare provider based on the first subscription fee and the second subscription fee; enabling, by the processor, the patient to access an electronically configured virtual consultation room that provides on-demand peer-to-peer consultations and on-demand communication between the patient and at least one of the healthcare provider and an entity; enabling, by the processor, the patient to access electronic data of an educational facility stored in the database; generating records comprising (i) suggestions comprising health awareness activities for the patient, (ii) health reports based on the health awareness activities, and (iii) recommended prescriptions based on at least one of the health awareness activities and the health reports; and displaying the generated records on a communication device.

The method may further comprise enabling, by the processor, (i) the patient an on-demand access to the healthcare provider to retrieve clinical data from a personal health record stored in the database, and (ii) coordination care by linking the patient and the healthcare provider. The method may further comprise providing the patient an on-demand access to a remotely accessible transcription service. The on-demand communication between the patient, the healthcare provider, and the entity may comprise an interactive session comprising any of an audio conference, a video conference, and a short message service (SMS). The method may further comprise integrating the audio conference, the video conference, and the SMS with any of Personal Health Records (PHR) and Electronic Health Records (EMR) associated with the patient and the healthcare provider. The method may further comprise storing, in a database, data associated with the patient, the healthcare provider, and other expert healthcare providers. The entity may comprise any of family members and friends associated with the patient, another healthcare provider, and a payer of healthcare services. These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a patient communicating with a medical healthcare system through a network using a communication device according to an embodiment herein;

FIG. 2 illustrates a block diagram of the medical healthcare system of FIG. 1 according to an embodiment herein;

FIG. 3 illustrates a user interface view of the medical healthcare system of FIG. 1 according to an embodiment herein;

FIG. 4A illustrates a user interface view of the consultation module of FIG. 2 according to an embodiment herein;

FIG. 4B illustrates a user interface view of the consultation module of FIG. 2 according to an embodiment herein;

FIG. 4C illustrates a user interface view of the consultation module of FIG. 2 according to an embodiment herein;

FIG. 5A illustrates a user interface view of the health monitoring module of FIG. 2 according to an embodiment herein;

FIG. 5B illustrates a user interface view of the health monitoring module of FIG. 2 according to an embodiment herein;

FIG. 5C illustrates a user interface view of the health monitoring module of FIG. 2 according to an embodiment herein;

FIGS. 6A and 6B illustrate user interface views of the medical education module of FIG. 2 according to an embodiment herein;

FIG. 7 illustrates a user interface view of the transcription module of FIG. 2 according to an embodiment herein;

FIGS. 8A and 8B illustrate user interface views of the personal health record (PHR) module of FIG. 2 according to an embodiment herein;

FIG. 9 illustrates a user interface view of the ecommerce store of FIG. 3 according to an embodiment herein;

FIG. 10 illustrates a computer system used in accordance with the embodiments herein;

FIG. 11 illustrates a block diagram of the communication device of FIG. 1 used in accordance with the embodiments herein; and

FIG. 12 is a flow diagram illustrating a method for providing personalized healthcare information and records specific to a healthcare delivery using the medical healthcare system of FIG. 1 according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

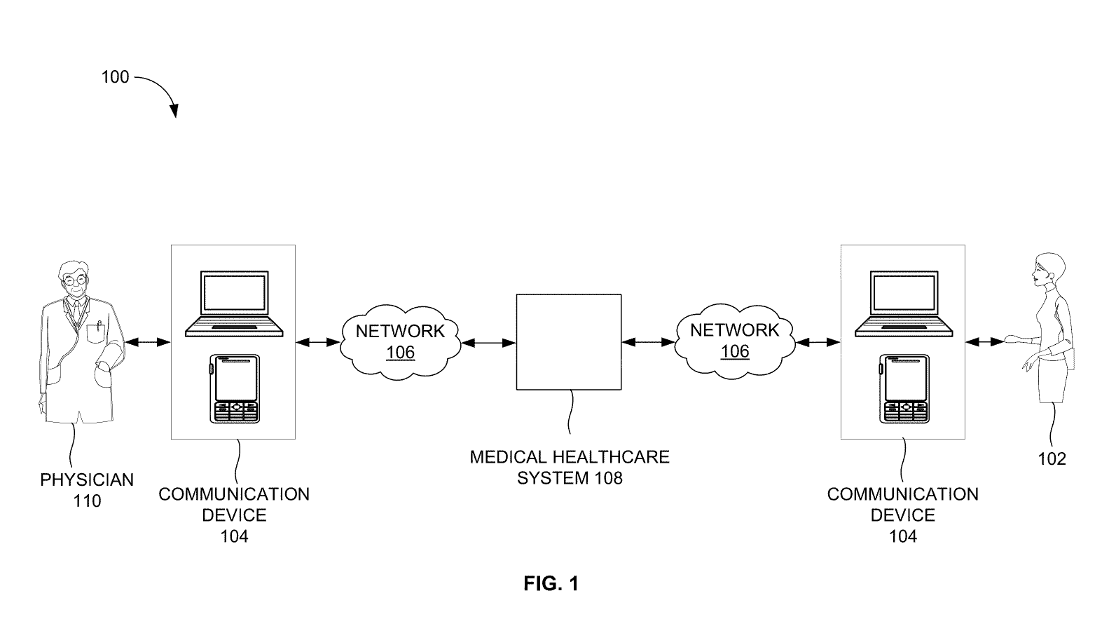

As mentioned, there remains a need for a system that unites and balances stakeholders' (e.g., patients and their families, physicians, and payors) incentives by providing an array of services through its mobile devices enabling better healthcare coordination, increased patient engagement, and improved satisfaction among its users. The embodiments herein achieve this by providing an electronic medical healthcare system that obtains (i) a first subscription fee from a patient for a physician that is specific to access (a) enhanced communication link for communication between said patient for the physician, and (b) healthcare information and records that are specific to a healthcare delivery of the patient, and (ii) a second subscription fee from the physician for utilizing a service provided by a medical healthcare system, enables the patient to access a consultation room that provides on-demand peer-to-peer consultations and on-demand communication between the patient and at least one of the physician and an entity, enables the patient to access an educational facility stored in the database, generates records comprising (i) suggestions comprising health awareness activities for the patient, (ii) health reports based on the health awareness activities, and (iii) recommended prescriptions based on at least one of the health awareness activities, and the health reports, and displays the generated records on a communication device. Referring now to the drawings, and more particularly to FIGS. 1 through 12, where similar reference characters denote corresponding features consistently throughout the figures, there are shown preferred embodiments.

FIG. 1 illustrates a system view of a patient 102 communicating with a medical healthcare system 108 through a network 106 using a communication device 104 according to an embodiment herein. The patient 102 registers with the medical healthcare system 108 for (a) establishing an enhanced communication link for communication between the patient 102 and a physician 110, and (b) healthcare information and records that are specific to a healthcare delivery of the patient 102. Here, the patient 102 provides a first subscription fee to a participating physician 110 (e.g., a medical professional, a medical specialist, a healthcare provider, or a hospital) for improved communication and increased access to healthcare information/records in connection with their healthcare delivery and coordination. The physician 110 provides a second subscription fee for utilizing a service provided by the medical healthcare system 108. The medical healthcare system (MHS) 108 provides the patient 102 an on-demand access to the physician 110 to retrieve clinical data from a personal health record (PHR) stored in the medical healthcare system 108, and to coordinate care by linking physicians, family members, and friends within a network associated with the patient 102 (e.g., using the communication device 104). The communication device 104 comprises a personal computer, a laptop, a tablet device, a smartphone, a mobile communication device, a personal digital assistant, a television, or any other such computing device, in one example embodiment.

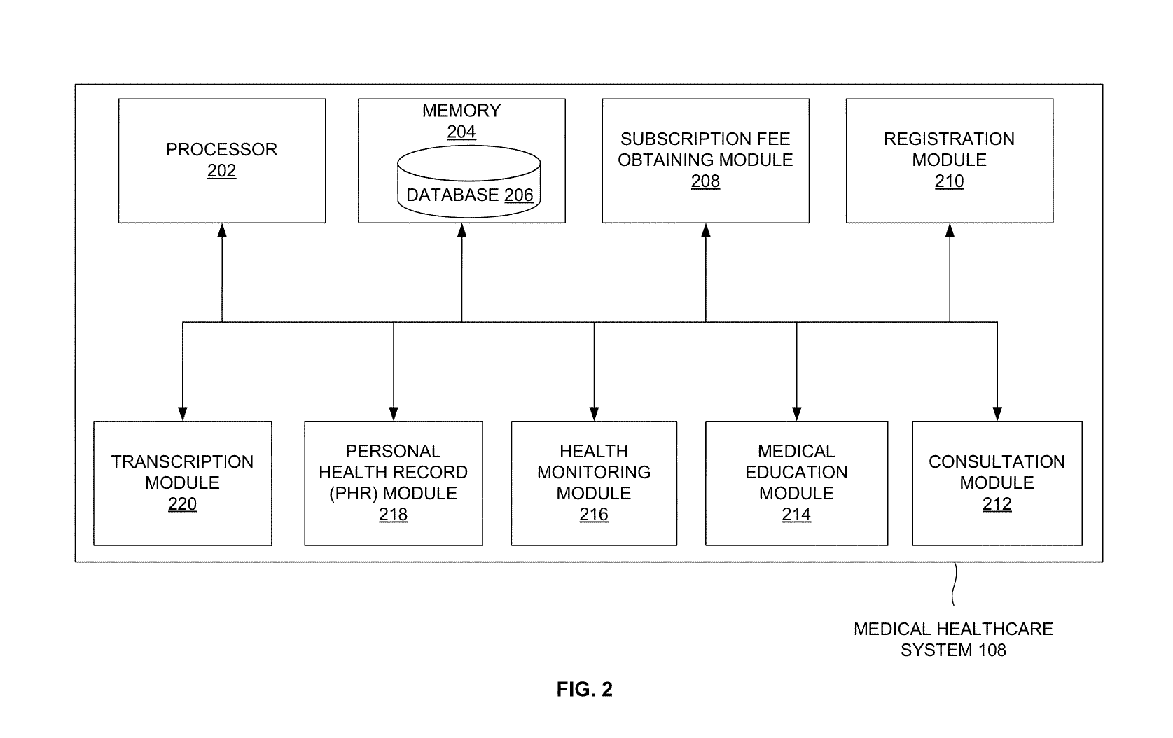

FIG. 2, with reference to FIG. 1, illustrates a block diagram of the medical healthcare system 108 of FIG. 1 according to an embodiment herein. The medical healthcare system 108 includes a processor 202, a memory 204 that stores instructions and a database 206, a subscription fee obtaining module 208, a registration module 210, a consultation module 212, a medical education module 214, a health monitoring module 216, a personal health record (PHR) module 218, and a transcription module 220. The processor 202 is configured by the instructions stored in the memory 204. The processor 202 executes the subscription fee obtaining module 208, the registration module 210, the consultation module 212, the medical education module 214, the health monitoring module 216, the personal health record (PHR) module 218, and the transcription module 220. The database 206 stores information associated with the patient 102, the physician 110, and other expert physicians. The subscription fee obtaining module 208 obtains a first subscription fee from the patient 102 for the physician 110. The first subscription fee is specific to access (a) an enhanced communication link for communication between the patient 102 and the physician 110, and (b) healthcare information and records that are specific to a healthcare delivery of the patient 102 Likewise, the subscription fee obtaining module 208 obtains a second subscription fee from the physician 110 for utilizing a service (e.g., a platform) provided by the medical healthcare system 108.

The registration module 210 registers the patient 102 and the physician 110 based on the first subscription fee and the second subscription fee. The medical healthcare system 108 enables enhanced secure communication to improve the coordination of care between healthcare providers, and on-demand communication between physicians, patients, and their family members or friends. The consultation module 212 enables the patient 102 to access a consultation room that provides on-demand peer-to-peer consultations and on-demand communication between the patient and at least one of the physician 110 (or other expert physicians) and/or an entity (e.g., family members and/or friends). The on-demand communication includes communication between the patient 102, the physician 110, and the entity is an interactive session comprising any of an audio conference, a video conference, and a short message service (SMS), in an example embodiment. The video conference, the audio conference, and the SMS are integrated with Personal Health Records (PHR) or Electronic Health Records (EMR) associated with the patient 102 and the physician 110. The medical education module 214 enables the patient 102 to access an educational facility stored in the database 206. The education facility includes digital notes, audio files, and video files that demonstrate using an emergency kit during an emergency, and/or any other such content that is useful for medical emergency, etc., in one example embodiment. The entity is any of family members and friends associated with the patient 102, and the physician 110.

The health monitoring module 216 generates records comprising (i) suggestions that include health awareness activities for the patient 102, (ii) health reports based on the health awareness activities, and (iii) recommended prescriptions based on the health awareness activities, the health reports, and/or combinations thereof. The personal health record module 218 enables (i) the patient 102 an on-demand access to the physician 110 to retrieve clinical data from a personal health record stored in the database 206 and (ii) coordination care by linking the patient 102 and the physician 110. The transcription module 220 enables the patient 102 an on-demand access to a transcription service provided by the medical healthcare system 108.

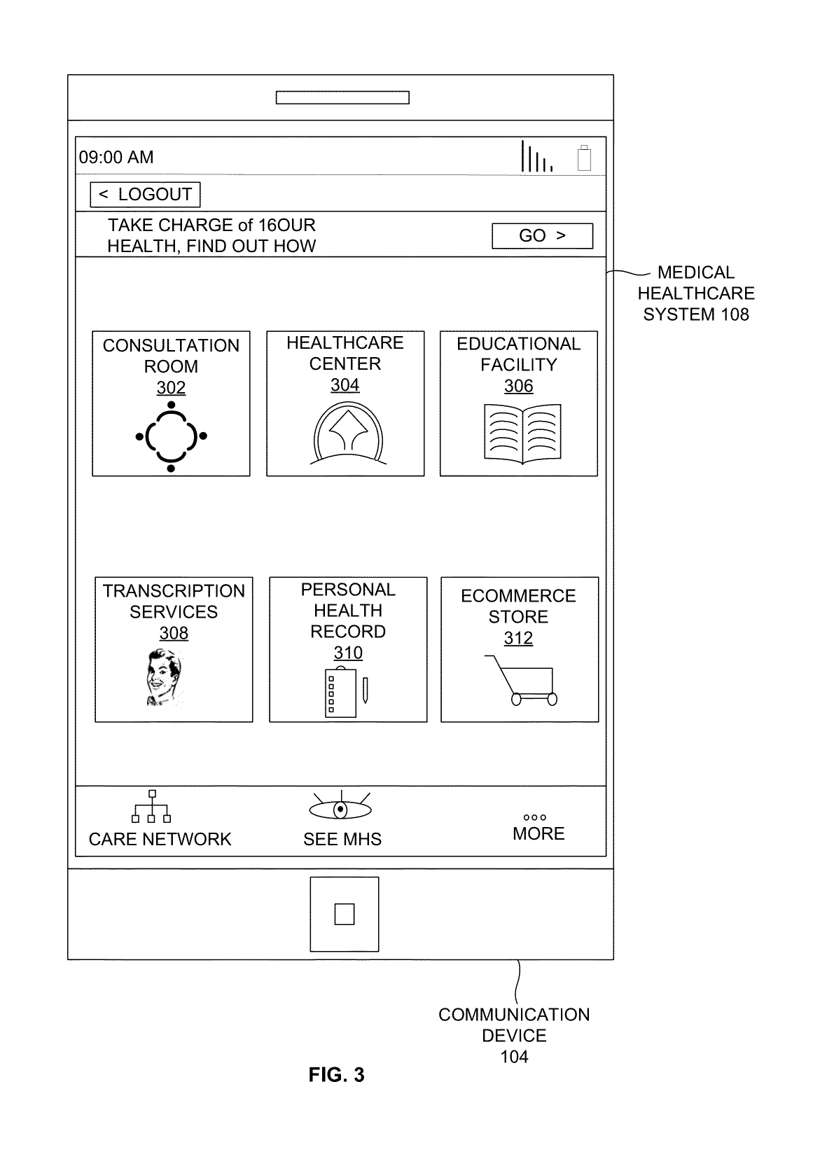

FIG. 3, with reference to FIGS. 1 and 2, illustrates a user interface view of the medical healthcare system 108 of FIG. 1 when executed on the communication device 104 of FIG. 1 associated with the patient 102 of FIG. 1 according to an embodiment herein. In particular, the user interface view of the medical healthcare system 108 illustrates enabling access to a consultation room 302, a healthcare center 304, an educational facility 306, a transcription service 308, a personal health record 310, and an ecommerce store 312.

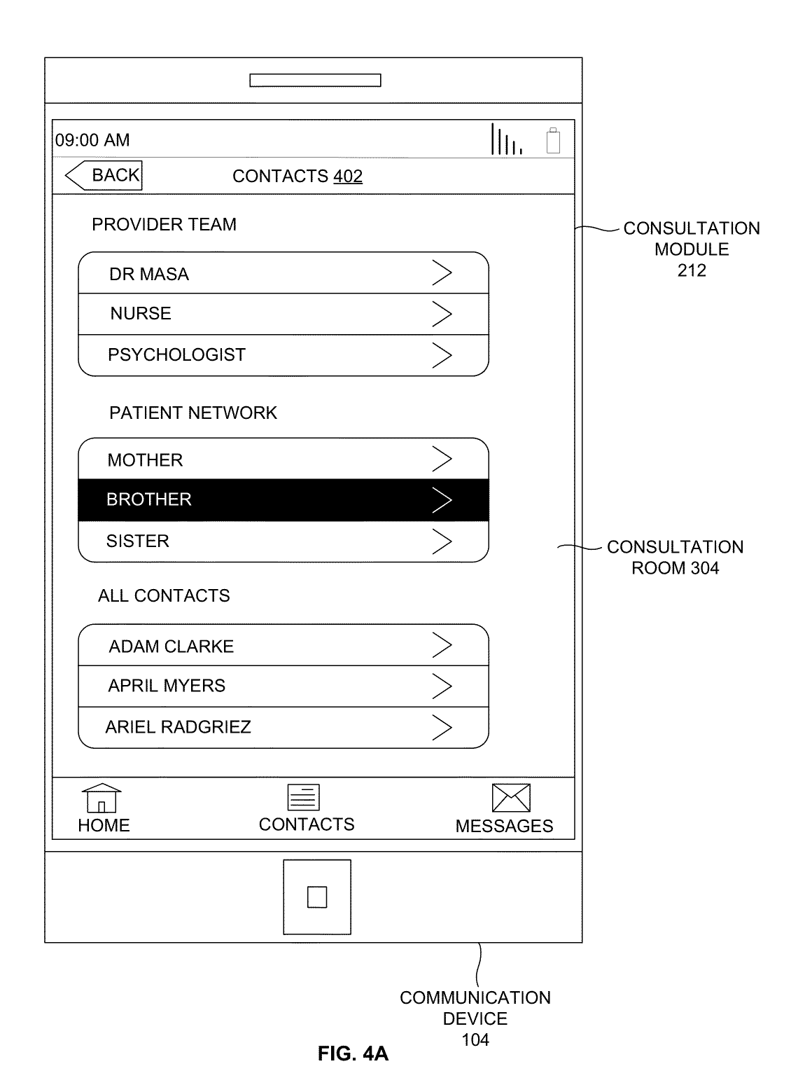

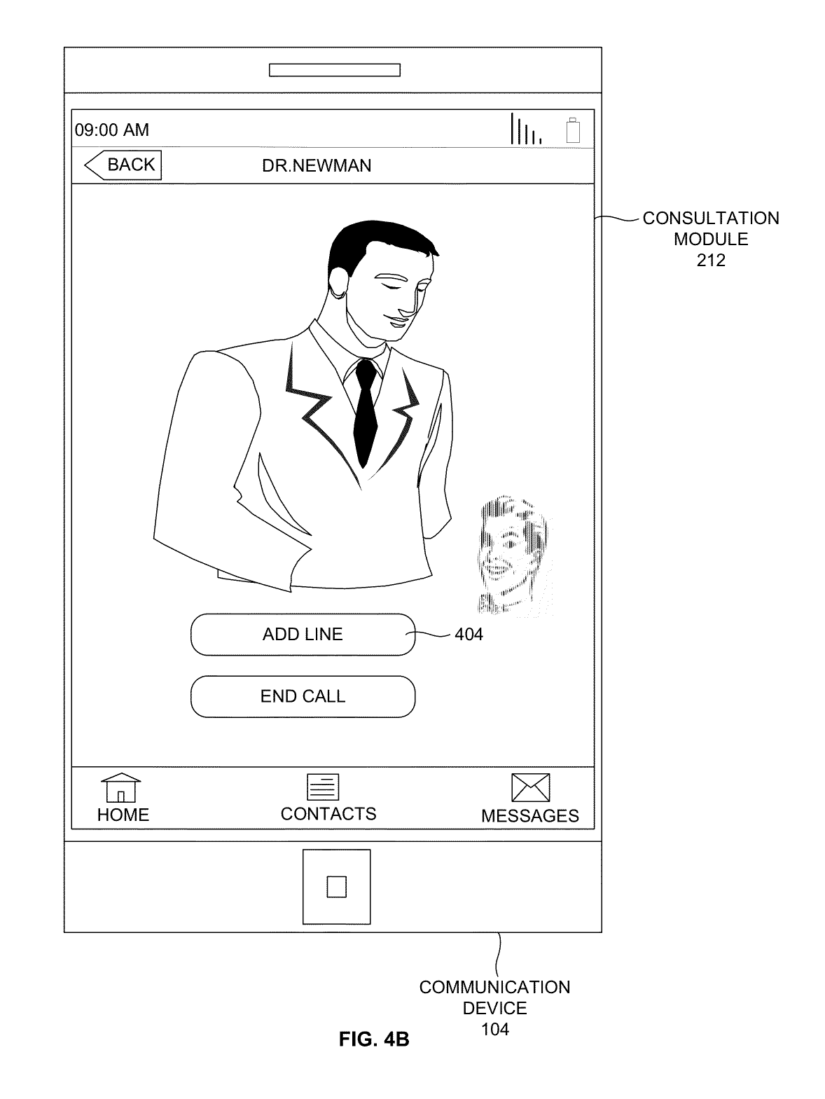

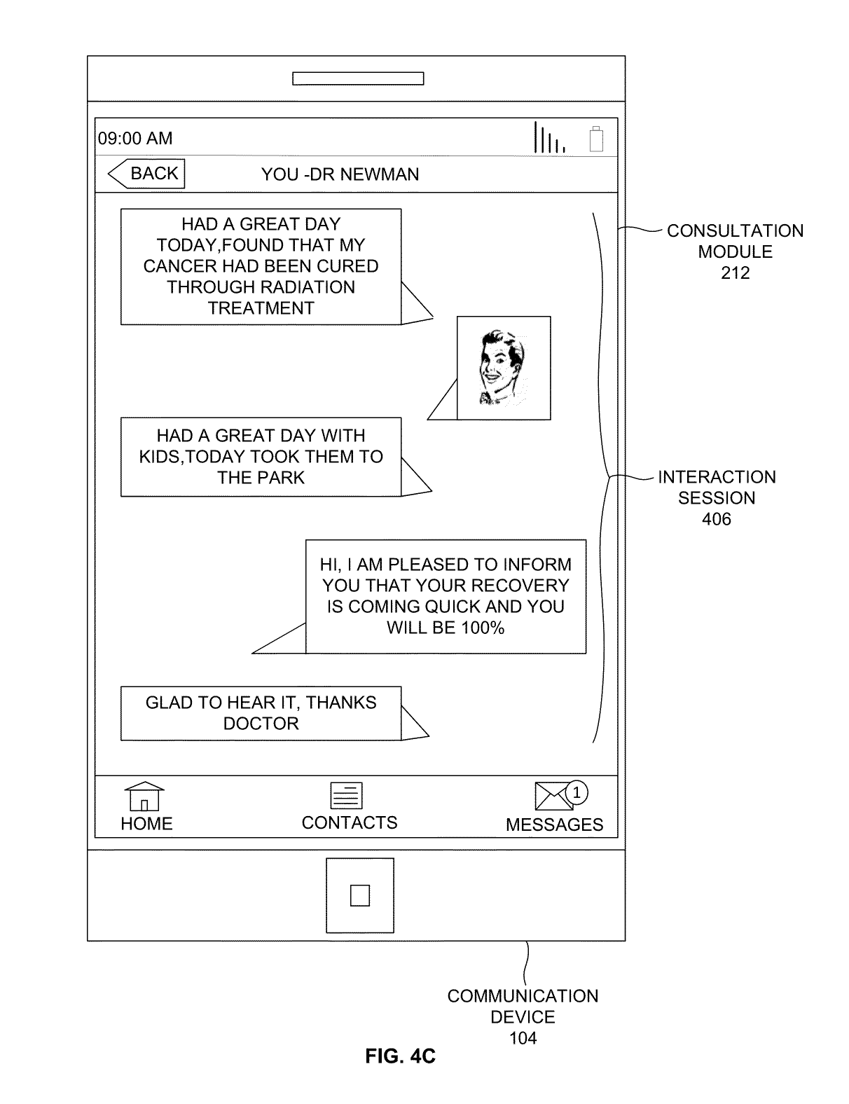

FIG. 4A, with reference to FIGS. 1 through 3, illustrates an user interface view of the consultation module 212 of FIG. 2 of the medical healthcare system 108 of FIG. 1 when executed on the communication device 104 of FIG. 1 associated with the patient 102 of FIG. 1 according to an embodiment herein. In particular, the user interface view of the consultation module 212 of FIG. 2 illustrates the consultation room 302. The consultation room 302 includes contacts field 402. The contacts field 402 includes one or more contact information associated with one or more physicians (e.g., the physician 110 and/or healthcare providers), and family members, and friends within the network of the patient 102.

FIG. 4B, with reference to FIG. 1 through FIG. 4A, illustrates an user interface view of the consultation module 212 of FIG. 2 of the medical healthcare system 108 of FIG. 1 when executed on the communication device 104 of FIG. 1 associated with the patient 102 of FIG. 1 according to an embodiment herein. In particular, the user interface view of the consultation module 212 depicts the patient 102 attempting a communication link to be established with a physician (e.g., Dr. Newman) 110 and the patient 102 using an add line button 404. The patient 102 may establish the communication link between the patient 102 and the physician 110 by providing an input to an add line button (e.g., a click).

FIG. 4C, with reference to FIGS. 1 through 4B, illustrates an user interface view of the consultation module 212 of FIG. 2 of the medical healthcare system 108 of FIG. 1 when executed on the communication device 104 of FIG. 1 associated with the patient 102 of FIG. 1 according to an embodiment herein. In particular, FIG. 4C depicts a user interface that illustrates an interactive session 406 between the patient 102 and the physician (e.g., Dr. Newman) 110 using the consultation module 212. The interactive session may include, for example, comments by the patient 102 “Had a great day today, found that my cancer had been cured through radiation treatment”, “Had a great day with kids, today took them to the park”. Likewise the interactive session includes, for example, conversation by the physician “Hi, I am pleased to inform you that your recovery is coming quick and you will be 100%”, etc.

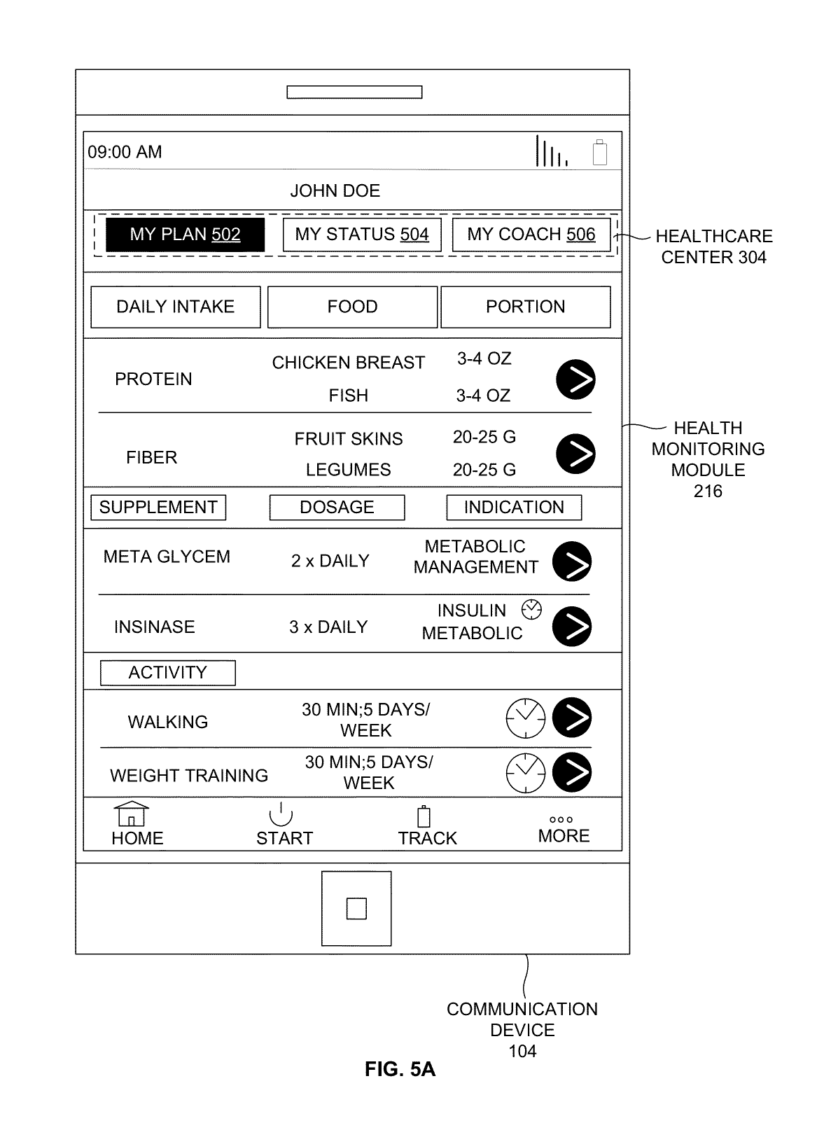

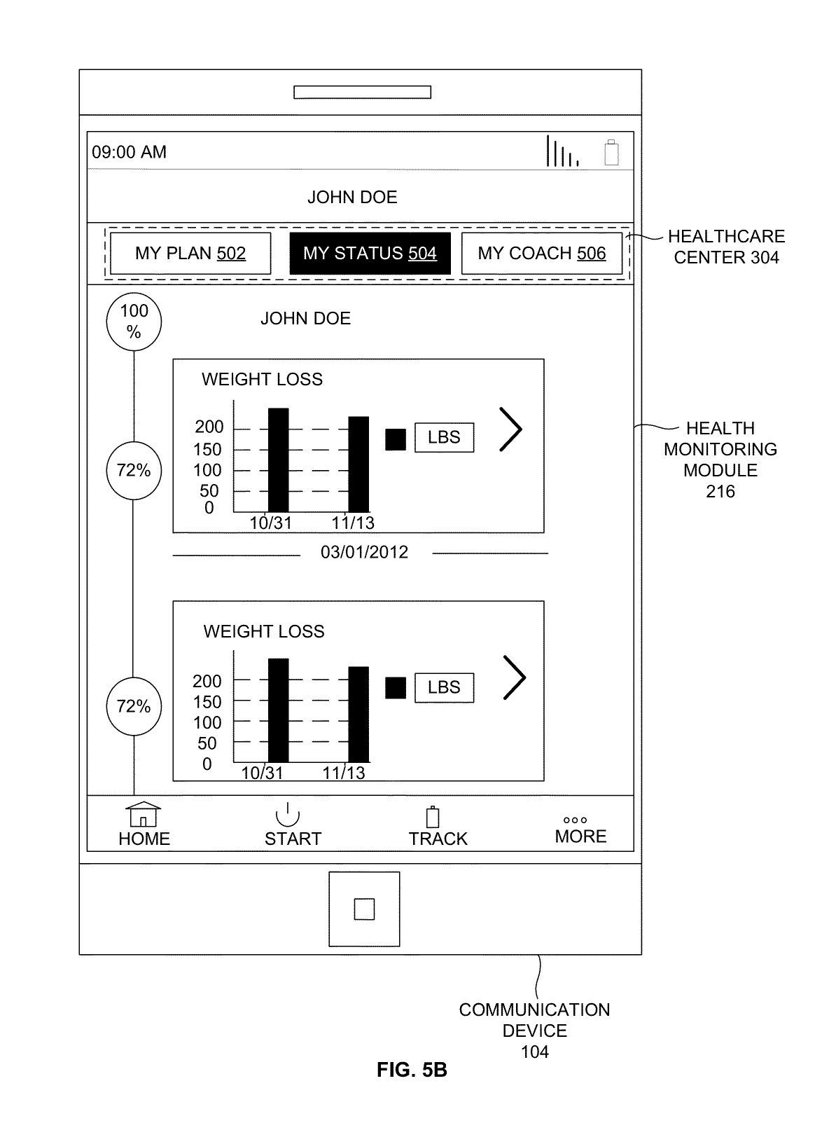

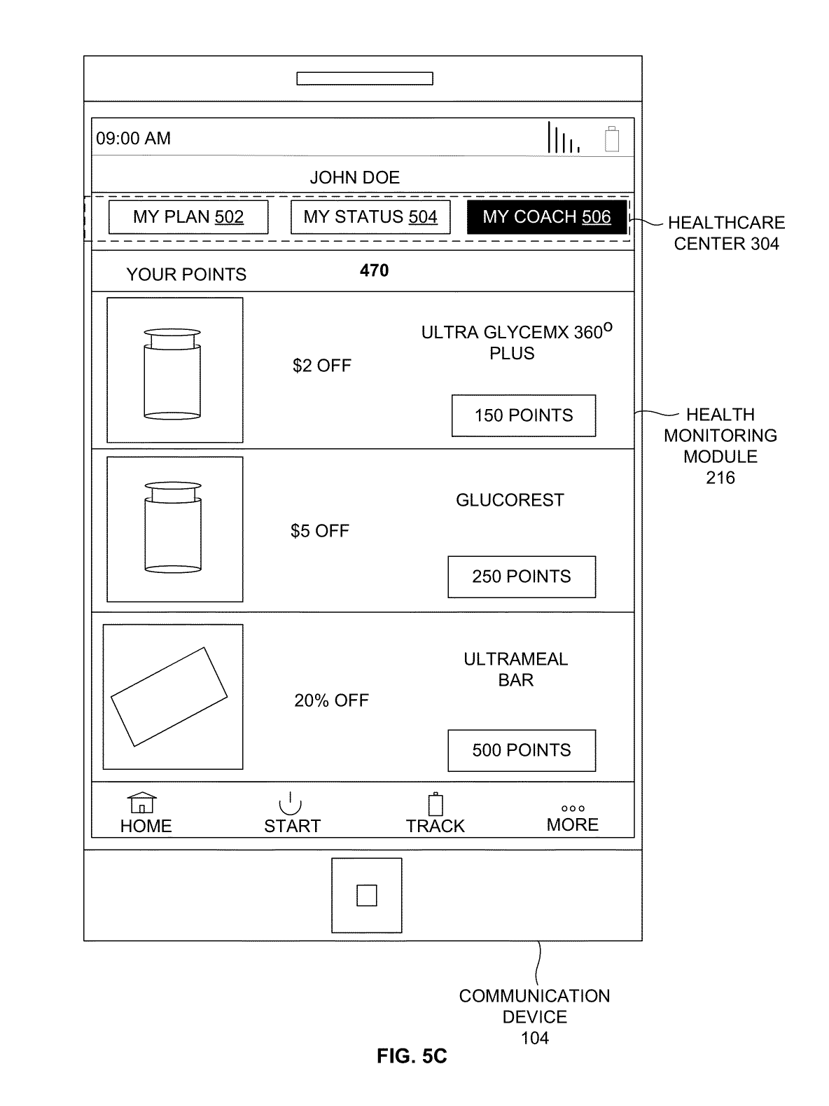

FIG. 5A, with reference to FIGS. 1 through 4C, is an user interface view of the health monitoring module 216 of FIG. 2 of the medical healthcare system 108 of FIG. 1 illustrating the healthcare center 304 of FIG. 3 for the patient 102 of FIG. 1 when executed on the communication device 104 of FIG. 1 associated with the patient 102 of FIG. 1 according to an embodiment herein. The user interface view of the health monitoring module 216 includes a my plan field 502, a my status field 504, and a my coach field 506. The my plan field 502 comprises suggestions that include health awareness activities for the patient 102 (e.g., John Doe). The health awareness activities may include daily intake information such as (i) protein (e.g., food such as chicken breast, and/or fish) and corresponding portions for daily intake (e.g., 3-4 OZ), and (ii) fiber (e.g., fruits skin and/or legumes) and corresponding portions for daily intake (e.g., 20-25 g). Likewise, the my plan field 502 includes supplement, corresponding dosages, and indications. For example, as depicted in FIG. 5A, supplement includes meta glycem, corresponding dosages twice a day, and indication for metabolic management. Likewise, supplement includes insinase, corresponding dosages thrice a day, and indication for insulin management. The my plan field 502 further includes activity that the patient 102 may work out such as walking for 30 mins-5 days a week, and weight training for 30 mins-5 days a week.

FIG. 5B, with reference to FIGS. 1 through 5A, is an user interface view of the health monitoring module 212 of FIG. 2 of the medical healthcare system 108 of FIG. 1 illustrating the healthcare center 304 of FIG. 3 for the patient 102 of FIG. 1 when executed on the communication device 104 of FIG. 1 associated with the patient 102 of FIG. 1 according to an embodiment herein. In particular, the user interface view of the health monitoring module 212 illustrates the my status field 504. The my status field 504 includes health records specific to the patient 102 (e.g., John Doe). The my status field 504 depicts a weight loss (in lbs., etc.) of John Doe for a particular time intervals (e.g., weigh loss information between Oct. 31, 2012 and Nov. 13, 2012).

FIG. 5C, with reference to FIGS. 1 through 5B, is an user interface view of the health monitoring module 212 of FIG. 2 of the medical healthcare system 108 of FIG. 1 illustrating the healthcare center 304 of FIG. 3 for the patient 102 of FIG. 1 when executed on the communication device 104 of FIG. 1 associated with the patient 102 of FIG. 1 according to an embodiment herein. In particular, the user interface view of the health monitoring module 212 illustrates the my coach field 506. The my coach field 506 depicts types of medicines that the patient 102 can undergo medication for a particular healthcare problem. The my coach field 506 may suggests (i) recommended prescriptions that include one or more medicines based on the health awareness activities for the patient 102, (ii) health reports that are generated based on the health awareness activities, etc., in one example embodiment. The recommended prescriptions include Ultra Glycemx 360° Plus, Glucorest, Ultrameal Bar, etc., in one example embodiment. The patient 102 may purchase one or more medicines based on the recommended prescriptions and earn bonus points as shown in FIG. 5C. The bonus points may be redeemed to purchase medicines (e.g., using one or more reward programs), in one example embodiment.

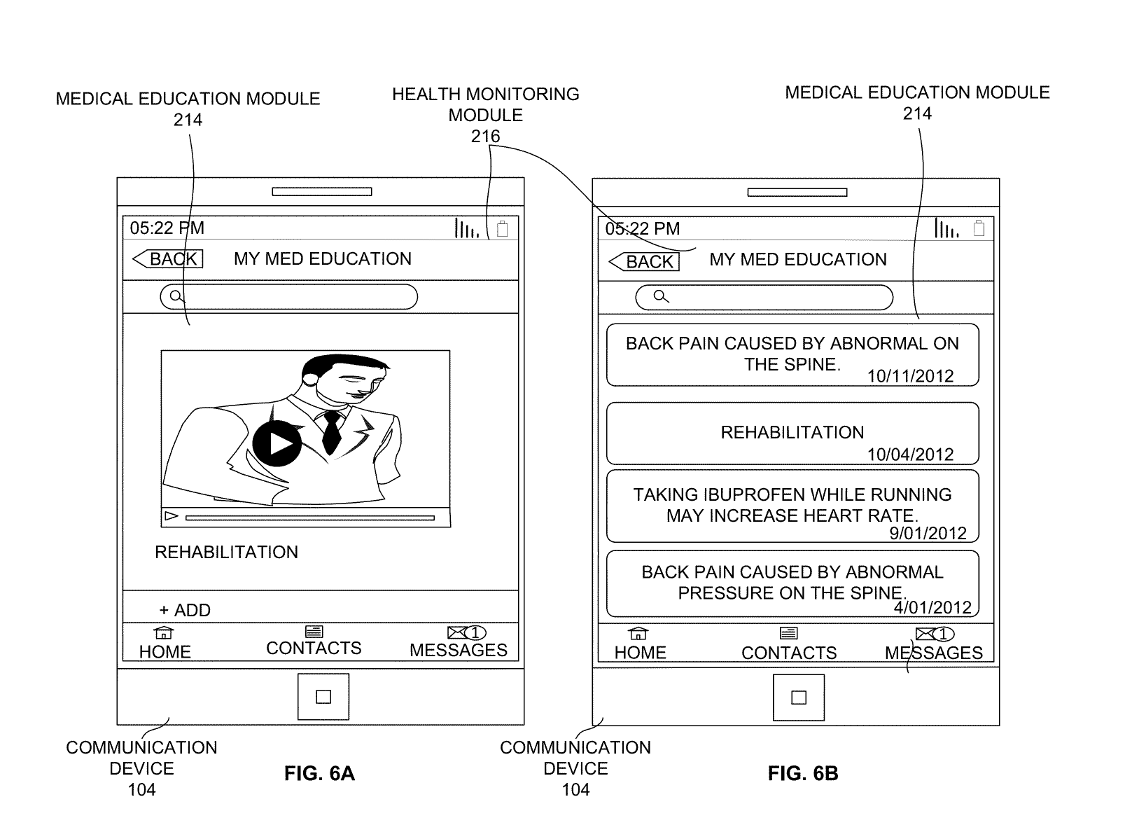

FIGS. 6A and 6B, with reference to FIGS. 1 through 5C, are user interface views of the medical education module 214 and health monitoring module 216 of FIG. 2 of the medical healthcare system 108 of FIG. 1 when executed on the communication device 104 of FIG. 1 associated with the patient 102 of FIG. 1 according to an embodiment herein. In particular, FIG. 6A depicts a video on rehabilitation. Likewise, FIG. 6B depicts a list of topics that include information on various healthcare problems/issue that facilitate the patient 102 an education for using one or more medicines under various ongoing prescriptions. The list of topics on various healthcare problems/issues includes “back pain caused by abnormal on the spine”, “rehabilitation”, “taking ibuprofen while running may increase heart rate”, and “back pain caused by abnormal pressure on the spine”, etc., in one example embodiment. When the patient 102 provides an input on at least one topic, at least one of a video, an audio, a text message, a presentation may be displayed to the patient 102.

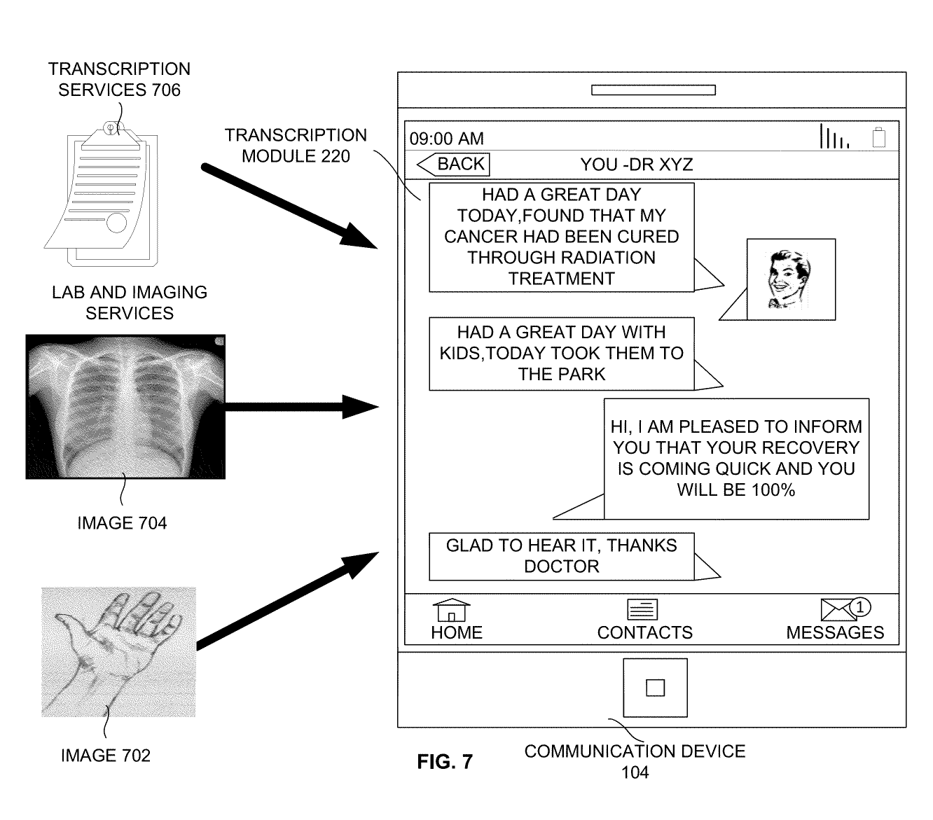

FIG. 7, with reference to FIGS. 1 through 6B, is a user interface view of the transcription module 220 of FIG. 2 of the medical healthcare system 108 of FIG. 1 when executed on the communication device 104 of FIG. 1 according to an embodiment herein. In particular, FIG. 7 depicts an interactive session between the patient 102 and the physician 110. The patient 102 captures an image 702 of a particular portion of his/her body (e.g., an arm as depicted in the FIG. 7) and share the image 702 with the physician for consultation. Likewise, as shown in FIG. 7, the physician 110 examines an X-ray 704 obtained from a lab and imaging services department, and provides consultation to the patient 102 based on the X-ray. The transcription service includes relevant clinical information. The interactive session includes utilizing a transcription service 706 by the patient 102 and the physician 110.

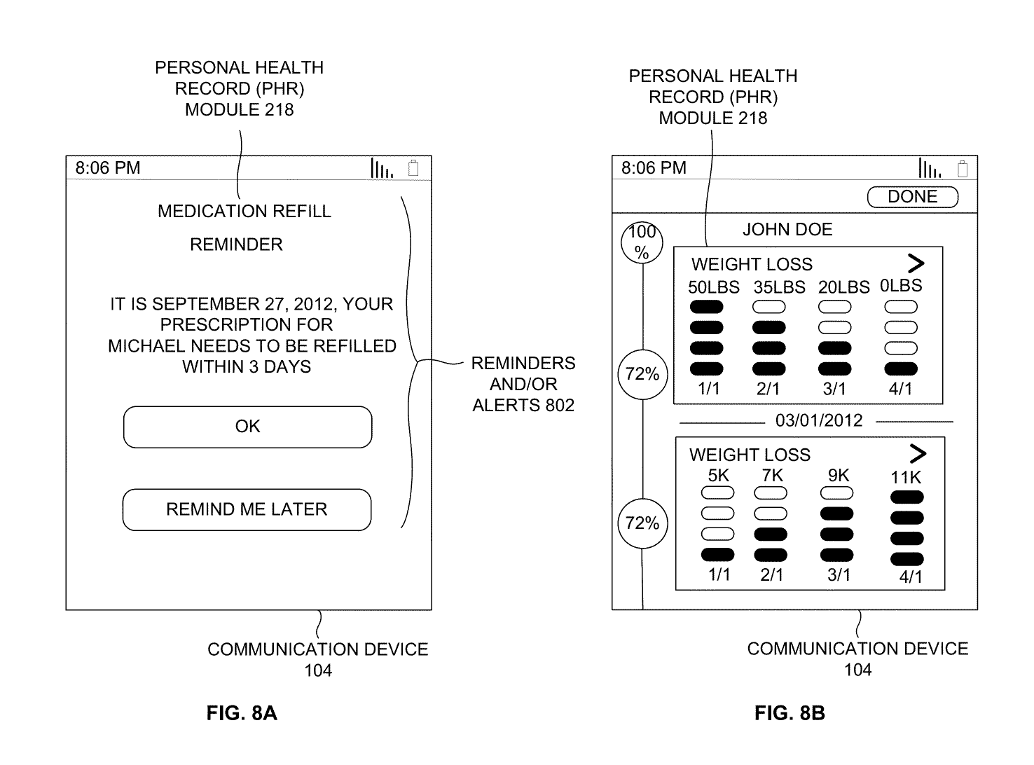

FIGS. 8A and 8B, with reference to FIGS. 1 through 7, are a user interface view of the personal health record (PHR) module 218 of FIG. 2 of the medical healthcare system 108 of FIG. 1 when executed on the communication device 104 of FIG. 1 according to an embodiment herein. In particular, FIG. 8A depicts reminders and/or alerts 802 that are displayed on a display screen of the communication device 104 associated with the patient 102. The reminder is “It is Sep. 27, 2012, your prescription for Michael needs to be refilled within 3 days”. The patient 102 (or any user who is operating the communication device 104) may either select OK, or remind me later option. FIG. 8B depicts personal health records of the patient 102 (e.g., John Doe). In particular, FIG. 8B depicts weight loss for a particular month (e.g., Mar. 1, 2012).

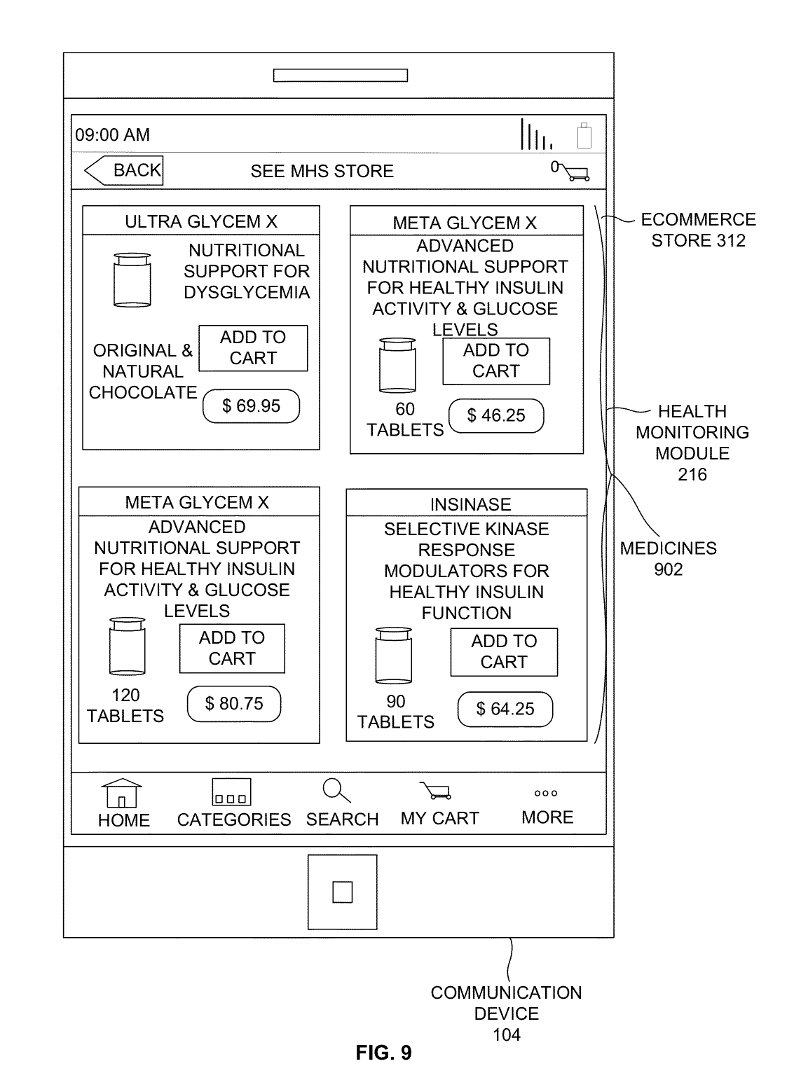

FIG. 9, with reference to FIGS. 1 through 8B, illustrates a user interface view of the ecommerce store 312 of FIG. 3 of the medical healthcare system 108 of FIG. 1 when executed on the communication device 104 of FIG. 1 associated with the patient 102 of FIG. 1 according to an embodiment herein. In particular, the ecommerce store 312 displays one or more medicines 902 to the patient 102. The patient 102 may purchase by adding them to a cart, checking out, and making the payments. The one or more medicines 902 are displayed to the patient 102 based on the recommended prescriptions, in one example embodiment. The one or more medicines 902 shown in FIG. 9 are merely examples (e.g., ULTRA GLYCEM X, META GLYCEM X, and INSINASE) without limitation. The recommended prescriptions may be provided by the physician 110, in yet another example embodiment. The recommended prescriptions may be generated (or suggested) by the health monitoring module 216 of FIG. 2, in a further example embodiment.

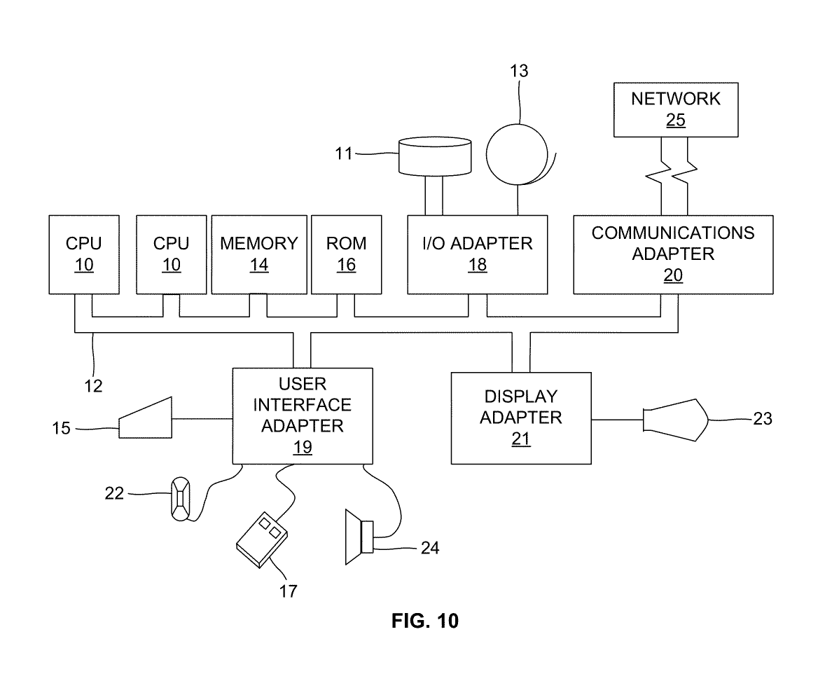

FIG. 10, with reference to FIGS. 1 through 9, is a computer system used in accordance with the embodiments herein. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a memory 14 (or the memory 204), read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The embodiments herein can include hardware and software embodiments. The embodiments that comprise software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

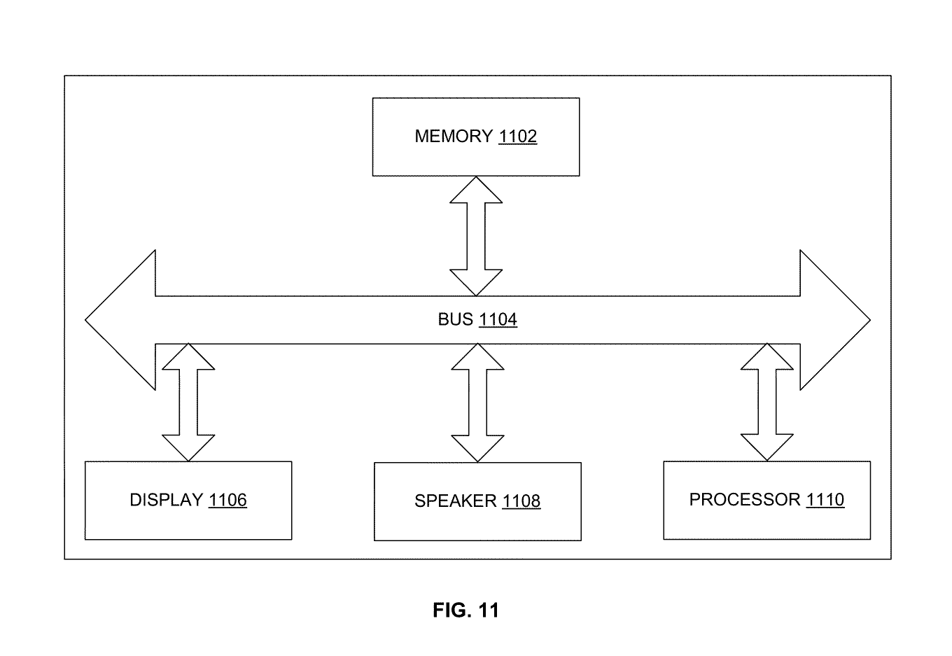

FIG. 11, with reference to FIGS. 1 through 10, illustrates block diagram of the communication device 104 of FIG. 1 having a memory 1102 having a set of computer instructions, a bus 1104, a display 1106, a speaker 1108, and a processor 1110 capable of processing the set of computer instructions to perform any one or more of the methodologies herein, according to an embodiment herein. The processor 1110 may also enable digital content to be consumed in the form of video for output via one or more displays 1106 or audio for output via speaker and/or earphones 1108. The processor 1110 may also carry out the methods described herein and in accordance with the embodiments herein.

Digital content may also be stored in the memory 1102 for future processing or consumption. The memory 1102 may also store program specific information and/or service information (PSI/SI), including information about digital content (e.g., the detected information bits) available in the future or stored from the past. A user (e.g., the production team) of the communication device 104 may view this stored information on display 1106 and select an item of for viewing, listening, or other uses via input, which may take the form of keypad, scroll, or other input device(s) or combinations thereof. When digital content is selected, the processor 1110 may pass information. The content and PSI/SI may be passed among functions within the communication device 104 using the bus 1104.

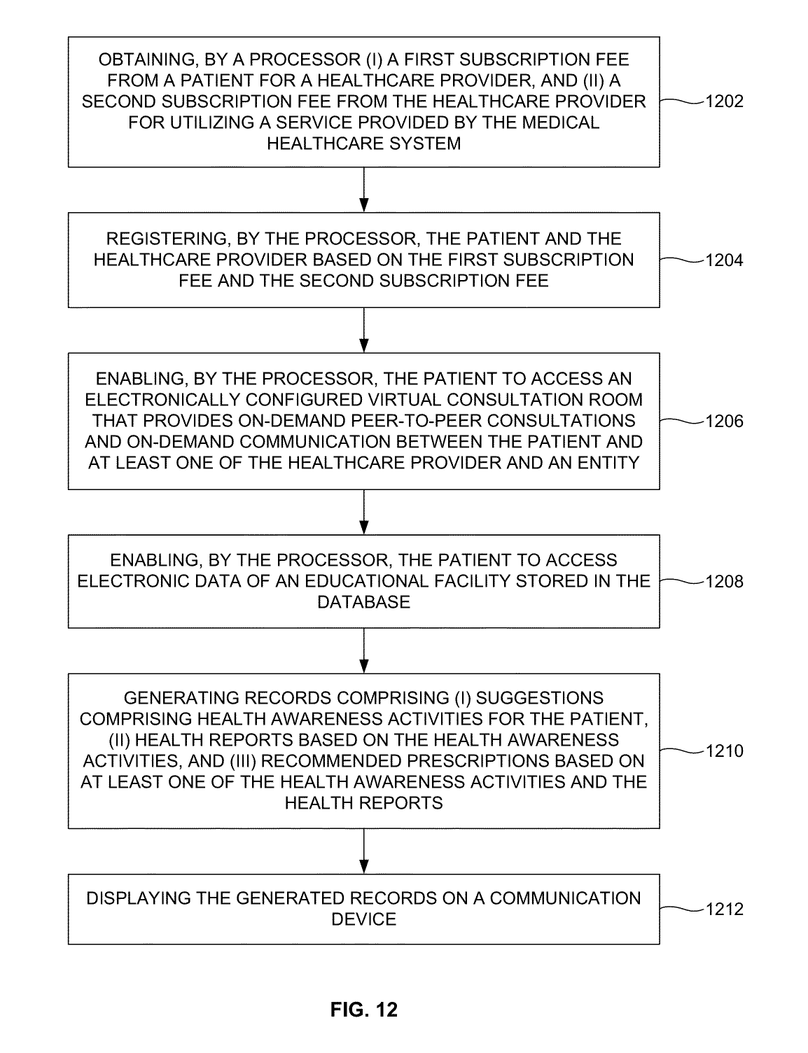

FIG. 12, with reference to FIGS. 1 through 11, is a flow diagram illustrating a method for providing personalized healthcare information and records specific to a healthcare delivery, the method comprising obtaining (1202), by a processor 202 (e.g., through the subscription fee obtaining module 208) (i) a first subscription fee from a patient 102 for a healthcare provider 110, wherein the first subscription fee is specific to access (a) a communication link for communication between the patient 102 and the healthcare provider 110, and (b) healthcare information and records that are specific to a healthcare delivery of the patient 102, and (ii) a second subscription fee from the healthcare provider 110 for utilizing a service provided by the medical healthcare system 108; registering (1204), by the processor 202 (e.g., through the registering module 210), the patient 102 and the healthcare provider 110 based on the first subscription fee and the second subscription fee; enabling (1206), by the processor 202 (e.g., through the consultation module 212), the patient 102 to access an electronically configured virtual consultation room 302 that provides on-demand peer-to-peer consultations and on-demand communication between the patient 102 and at least one of the healthcare provider 110 and an entity; enabling (1208), by the processor 202 (e.g., through the medical education module 214), the patient 102 to access electronic data of an educational facility 306 stored in the database 206; generating (1210) records (e.g., through the personal health record (PHR) module 218) comprising (i) suggestions comprising health awareness activities for the patient 102, (ii) health reports based on the health awareness activities, and (iii) recommended prescriptions based on at least one of the health awareness activities and the health reports; and displaying (1212) the generated records on a communication device 104.

The method may further comprise enabling, by the processor 202 (e.g., through the personal health record (PHR) module 218), (i) the patient 102 an on-demand access to the healthcare provider 110 to retrieve clinical data from a personal health record stored in the database 206, and (ii) coordination care by linking the patient 102 and the healthcare provider 110. The method may further comprise providing (e.g., through the transcription module 220) the patient 102 an on-demand access to a remotely accessible transcription service. The on-demand communication between the patient 102, the healthcare provider 110, and the entity may comprise an interactive session comprising any of an audio conference, a video conference, and a short message service (SMS). The method may further comprise integrating the audio conference, the video conference, and the SMS with any of Personal Health Records (PHR) and Electronic Health Records (EMR) associated with the patient 102 and the healthcare provider 110. The method may further comprise storing, in a database 206, data associated with the patient 102, the healthcare provider 110, and other expert healthcare providers 110. The entity may comprise any of family members and friends associated with the patient 102, another healthcare provider 110, and a payer of healthcare services.

The medical healthcare system 108 enables an enhanced communication and increased access to healthcare information/records in connection with their healthcare delivery and coordination between the patient 102 and the physician 110 by allowing the patient 102 pay an annual subscription fee to their participating physician, specialist, or hospital. Participating providers (e.g., the physician 110) pay a nominal access fee to the medical healthcare system 108 for utilizing one or more services/facilities provided by the medical healthcare system 108 in order to communicate and interact with their patients, thus enabling (i) increased patient access to care (in an “on demand” format), (ii) timely delivery and coordination of patient care; (iii) decreased hospital admission/readmission and (iv) greater efficiency in communication among clinical care providers, as well as between patients 102 (and their families or friends) and their physicians 110.

The medical healthcare system 108 (i) improves overall quality of care, (ii) facilitates improved clinical outcomes of patients, (iii) increases the patient 102 and the physician satisfaction with the delivery of care, and (iv) reduces cost of care to payors, providers and patients. The medical healthcare system 108 enhances the ability of a healthcare provider to deliver better, faster care. The medical healthcare system 108 empowers the patient 102 to have greater control over their clinical experience by enabling an on-demand access to their healthcare provider to retrieve clinical data in their personal health record (“PHR”), and to coordinate care by linking physicians, family members and friends within the patient's network by providing peer-to-peer consults and communications on the one hand, and between patients (and their family, caretakers, and friends) and physicians, on the other hand. The peer-to-peer consults and communications include, but are not limited to, (i) real-time video, on-demand video, and image transfer anytime and anywhere, (ii) texting and email tools, (iii) sensor device data-feed streaming to physicians and allied health professionals, and offering real-time clinical statuses and data to guide treatment plans, (iv) medication reconciliation and dynamic feedback governing patient medication regimens, (v) data-feeds to the medical healthcare system's personal health record (“PHR”) and bidirectional feeds from hospital/physician based PHRs, (vi) communication exchange between the patient 102 and the physician 110 in a format that seamlessly creates documentation for EHR and for eventual telemedicine-based reimbursements through creation of a patient communication and care coordination cluster, (vii) individualized PHR's that enable connectivity with the patient's physician and other vendors, facilitated by being built on a health vault platform, (viii) data capture and data mining, (ix) mechanisms for enhanced direct-to-consumer advertising based on the patient specific data, (x) a patient-centric social media platform that will augment the growth of the medical healthcare system 108 and enhance connectivity and the patient experience, and (xi) transcription services.

Through the above features, patients 102 will be able to access their medical records, send and receive text messages, voicemail and video with their healthcare providers 110, invite family and friends into their network for plan-of-care and coordination-of-care purposes, and actively participate in their treatment and/or recovery. Participating patients 102 are not paying physicians 110 for actual clinical care, but rather, the patients 102 are paying for enhanced methods of communication and access to healthcare information and records in connection with their healthcare delivery.

Further, through the medical healthcare system 108, patients 102 and physicians 110 alike will co-market products. Patients 102 are introduced to the medical healthcare system 108 either in the office or in a hospital, where their frustration with poor communication is greatest. The price point in the hospital will be set to increase subscriptions from patients who, content with their new experience, will bring the products to their outpatient physicians, thus negating the need for physician promotion. In addition, primary care physicians and hospital based physicians will introduce patients to the medical healthcare system 108, covering an on-demand physician interaction (e.g., the physician's time) and access to the medical healthcare system 108 to personalized healthcare.

Participating physicians 110 will offer the medical healthcare system 108 to all patients on an equal basis without regard for the patient's insurance coverage status. Further, the patients 102 will pay the hospital a flat fee per hospital stay to participate in the medical healthcare system 108 (e.g., the “Hospitalist Access Fee”) and each participating hospital will pay a per-patient subscription fee to the “Hospitalist IT Subscription Fee”. The medical healthcare system 108 acts as an administrative agent on behalf of the physicians 110 and hospitals for purposes of billing and collecting the access fees from patients. Patients elect to participate in the medical healthcare system 108 based on existing and well-established physician-patient relationships. Physician specialists are linked into the medical healthcare system 108 only at the election of the patient 102. Any referrals of clinical services among healthcare providers will take place only in conjunction with the plan and coordination of care of the particular patient 102 and the patient's respective provider network. The medical healthcare system 108 when executed on the communication device 104 enables the patient 102 and/or the physician 110 to chat, share a video (or an image), leave a voice message, sort the contacts and title text next to the conversations (e.g., sort by date, time, duration), plot address on a web mapping service application and technology, initiate a call between the patient 102, the physician 110, the entity and/or other expert physicians, add content to repository (e.g., the database 206), etc.

Generally, the embodiments herein provide a medical healthcare system 108 and computer-implemented method for providing personalized healthcare information and records specific to a healthcare delivery, the medical healthcare system 108 comprising a processor 202; a database 206; a memory 204 storing computer-executable instructions, wherein the processor 202 executes the computer-executable instructions; a subscription fee obtaining module 208 executed by the processor 202, wherein the subscription fee obtaining module 208 obtains (i) a first subscription fee from a patient for a healthcare provider 110, wherein the first subscription fee is specific to access (a) a communication link for communication between the patient and the healthcare provider 110, and (b) healthcare information and records that are specific to a healthcare delivery of the patient, and (ii) a second subscription fee from the healthcare provider 110 for utilizing a service provided by the medical healthcare system 108; a registration module 210 executed by the processor 202 that registers the patient and the healthcare provider 110 based on the first subscription fee and the second subscription fee; a consultation module 212 executed by the processor 202 that enables the patient to access an electronically configured virtual consultation room that provides on-demand peer-to-peer consultations and on-demand communication between the patient and at least one of the healthcare provider 110 and an entity (not shown); and a medical education module 214 executed by the processor 202 that enables the patient to access electronic data of an educational facility stored in the database 206.

The medical healthcare system 108 may further comprise a health monitoring module 216 executed by the processor 202, wherein the health monitoring module 216 generates (i) suggestions comprising health awareness activities for the patient, (ii) health reports based on the health awareness activities, and (iii) recommended prescriptions based on at least one of the health awareness activities and the health reports. The medical healthcare system 108 may further comprise a personal health record (PHR) module 218 executed by the processor 202, wherein the personal health record (PHR) module 218 enables (i) the patient an on-demand access to the healthcare provider 110 to retrieve clinical data from a personal health record stored in the database 206, and (ii) coordination care by linking the patient and the healthcare provider 110. The medical healthcare system 108 may further comprise a transcription module 220 executed by the processor 202, wherein the transcription module 220 enables the patient an on-demand access to a remotely accessible transcription service.

The on-demand communication between the patient, the healthcare provider 110, and the entity may comprise an interactive session comprising any of an audio conference, a video conference, and a short message service (SMS). The audio conference, the video conference, and the SMS may be integrated with any of Personal Health Records (PHR) and Electronic Health Records (EMR) associated with the patient and the healthcare provider 110. The database 206 may store data associated with the patient, the healthcare provider 110, and other expert healthcare providers 110. The entity may comprise any of family members and friends associated with the patient, another healthcare provider 110, and a payer of healthcare services.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for providing personalized healthcare information and records specific to a healthcare delivery, said system comprising:
a processor;
a database;
a memory storing computer-executable instructions, wherein said processor executes said computer-executable instructions;
a subscription fee obtaining module executed by said processor, wherein said subscription fee obtaining module obtains (i) a first subscription fee from a patient for a healthcare provider, wherein said first subscription fee is specific to access (a) a communication link for communication between said patient and said healthcare provider, and (b) healthcare information and records that are specific to a healthcare delivery of said patient, and (ii) a second subscription fee from said healthcare provider for utilizing a service provided by said medical healthcare system;
a registration module executed by said processor that registers said patient and said healthcare provider based on said first subscription fee and said second subscription fee;
a consultation module executed by said processor that enables said patient to access an electronically configured virtual consultation room that provides on-demand peer-to-peer consultations and on-demand communication between said patient and at least one of said healthcare provider and an entity; and
a medical education module executed by said processor that enables said patient to access electronic data of an educational facility stored in said database.

2. The system of claim 1, further comprising a health monitoring module executed by said processor, wherein said health monitoring module generates (i) suggestions comprising health awareness activities for said patient, (ii) health reports based on said health awareness activities, and (iii) recommended prescriptions based on at least one of said health awareness activities and said health reports.

3. The system of claim 1, further comprising a personal health record module executed by said processor, wherein said personal health record module enables (i) said patient an on-demand access to said healthcare provider to retrieve clinical data from a personal health record stored in said database, and (ii) coordination care by linking said patient and said healthcare provider.

4. The system of claim 1, further comprising a transcription module executed by said processor, wherein said transcription module enables said patient an on-demand access to a remotely accessible transcription service.

5. The system of claim 1, wherein said on-demand communication between said patient, said healthcare provider, and said entity comprises an interactive session comprising any of an audio conference, a video conference, and a short message service (SMS).

6. The system of claim 5, wherein said audio conference, said video conference, and said SMS are integrated with any of Personal Health Records (PHR) and Electronic Health Records (EMR) associated with said patient and said healthcare provider.

7. The system of claim 1, wherein said database stores data associated with said patient, said healthcare provider, and other expert healthcare providers.

8. The system of claim 1, wherein said entity comprises any of family members and friends associated with said patient, another healthcare provider, and a payer of healthcare services.

9. A system for providing personalized healthcare information and records specific to a healthcare delivery, said system comprising:
a processor;
a database;
a first computer-executable module executed by said processor, wherein said first module obtains (i) a first subscription fee from a patient for a healthcare provider, wherein said first subscription fee is specific to access (a) a communication link for communication between said patient and said healthcare provider, and (b) healthcare information and records that are specific to a healthcare delivery of said patient, and (ii) a second subscription fee from said healthcare provider for utilizing a service provided by said system;
a second computer-executable module executed by said processor, wherein said second computer-executable module registers said patient and said healthcare provider based on said first subscription fee and said second subscription fee;
a third computer-executable module executed by said processor, wherein said third computer-executable module enables said patient to access an electronic virtual consultation room that provides on-demand peer-to-peer consultations and on-demand communication between said patient and at least one of said healthcare provider and an entity;
a fourth computer-executable module executed by said processor, wherein said fourth computer-executable module enables said patient to access electronic data from an educational facility stored in said database;
a fifth computer-executable module executed by said processor, wherein said fifth computer-executable module generates (i) suggestions comprising health awareness activities for said patient, (ii) health reports based on said health awareness activities, and (iii) recommended prescriptions based on at least one of said health awareness activities and said health reports; and
a sixth computer-executable module executed by said processor, wherein said sixth computer-executable module enables (i) said patient an on-demand communicative access to said healthcare provider to retrieve clinical data from a personal health record stored in said database, and (ii) coordination care by linking said patient and said healthcare provider.

10. The system of claim 9, further comprising a seventh computer-executable module executed by said processor, wherein said seventh computer-executable module enables said patient an on-demand communicative access to a remotely located transcription service.

11. The system of claim 9, wherein said on-demand communication between said patient, said healthcare provider, and said entity comprises an interactive session comprising any of an audio conference, a video conference, and a short message service (SMS).

12. The system of claim 9, further comprising a communication device that facilitates access and interaction to said system by any of said patient, said healthcare provider, and an entity.

13. The system of claim 9, wherein said entity comprises any of family members and friends associated with said patient, another healthcare provider, and a payer of healthcare services.

14. A method for providing personalized healthcare information and records specific to a healthcare delivery, said method comprising:
obtaining, by a processor (i) a first subscription fee from a patient for a healthcare provider, wherein said first subscription fee is specific to access (a) a communication link for communication between said patient and said healthcare provider, and (b) healthcare information and records that are specific to a healthcare delivery of said patient, and (ii) a second subscription fee from said healthcare provider for utilizing a service provided by said system;
registering, by said processor, said patient and said healthcare provider based on said first subscription fee and said second subscription fee;
enabling, by said processor, said patient to access an electronically configured virtual consultation room that provides on-demand peer-to-peer consultations and on-demand communication between said patient and at least one of said healthcare provider and an entity;
enabling, by said processor, said patient to access electronic data of an educational facility stored in said database;
generating records comprising (i) suggestions comprising health awareness activities for said patient, (ii) health reports based on said health awareness activities, and (iii) recommended prescriptions based on at least one of said health awareness activities and said health reports; and
displaying the generated records on a communication device.

15. The method of claim 14, further comprising enabling, by said processor, (i) said patient an on-demand access to said healthcare provider to retrieve clinical data from a personal health record stored in said database, and (ii) coordination care by linking said patient and said healthcare provider.

16. The method of claim 14, further comprising providing said patient an on-demand access to a remotely accessible transcription service.

17. The method of claim 14, wherein said on-demand communication between said patient, said healthcare provider, and said entity comprises an interactive session comprising any of an audio conference, a video conference, and a short message service (SMS).

18. The method of claim 17, further comprising integrating said audio conference, said video conference, and said SMS with any of Personal Health Records (PHR) and Electronic Health Records (EMR) associated with said patient and said healthcare provider.

19. The method of claim 14, further comprising storing, in a database, data associated with said patient, said healthcare provider, and other expert healthcare providers.

20. The method of claim 14, wherein said entity comprises any of family members and friends associated with said patient, another healthcare provider, and a payer of healthcare services.
